(19) United States
(12) Patent Application Publication
(10) Pub. No.: US 2005/0110171 A1
(43) Pub. Date: May 26, 2005

(54) Method for mixing fuel and air and a device for processing the method

(76) Inventors: Te-Min Yang, Taipei (TW); Chien-Kuo Wang, Taipei (TW)

Correspondence Address: Mr. Phillip LIU, 6980, Whiteoak Dr., Richmond, BC, V7E 4Z9, CA

(21) Appl. No.: 10/718,671

(22) Filed: Nov. 24, 2003

(51) Int. Cl. F02M 29/04

(52) U.S. Cl. 261/78.1; 261/DIG. 55

(57) ABSTRACT

A fuel and air mixing device includes a tank for receiving fuel therein and a compressor on a top of the tank is connected to a first port of a mixing device and a valve assembly having a pipe connected to a second port of the mixing device. A siphon is connected to the valve assembly and extends in the fuel in the tank so as to siphon the fuel to go through the mixing device to form smaller particles which are entered the tank and mixed with air provided by the compressor. The mixture is then sent to an outlet of the valve assembly. A control unit is connected to the valve assembly and the compressor for a convenience of operation to the users.

### FIELD OF THE INVENTION

The present invention relates to a fuel and air mixing device which employs a siphon to suck fuel to be mixed with pressurized air.

### BACKGROUND OF THE INVENTION

A conventional way of delivery of fuel is to connect pipes from the source end to the user end. This is not suitable to install pipes to individual houses so that the fuel can be received in containers under certain pressure. The fuel is kept in liquid status in the container and vaporized before being used. Nevertheless, it is dangerous for keeping fuel in a pressurized container because any leakage or spark could explode the fuel. Another way is to stir the fuel and provided with air so as to expect the vapor of the fuel to be mixed with the air. During stirring, the air absorbs heat from the fuel and the fuel cannot be vaporized under a certain temperature. This limits the quantity and quality of the mixture of the fuel and air.

The present invention intends to provide a fuel and air mixing device that is easily operated and the mix process is monitored by controlling temperature and pressure so as to have desired mixture.

### SUMMARY OF THE INVENTION

The present invention relates to a fuel and air mixing device which includes a tank for receiving fuel therein and a mixing device is connected to a compressor and a valve assembly respectively. A siphon is connected to the valve assembly and extends in the fuel in the tank so as to siphon the fuel to go through the mixing device to form smaller particles which are entered the tank and mixed with air provided by the compressor. The mixture is then sent to an outlet of the valve assembly. A control unit is connected to the valve assembly and the compressor for a convenience of operation to the users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the fuel and air mixing device with the tank;

FIG. 2 shows the arrangement of the compressor, the mixing device, the valve assembly, the control unit on a top of the tank;

FIG. 3 shows fuel is siphoned from the tank and goes through the mixing device to be small particles which enter the tank again;

FIG. 4 shows that the small particles are mixed with air in the tank and the mixture is sent out via the valve assembly;

FIG. 5 shows that an operation panel is connected to a cover on the tank;

FIG. 6 shows pressurized air is sent into the tank via the first port of the mixing device;

FIG. 7 shows siphoned fuel is sent into the tank via the second port of the mixing device, and

FIG. 8 shows a block diagram of the connection of the control unit and the rest of the function parts.

### DETAILED DESCRIPTION OF THE PREFERRED EMBODIMENT

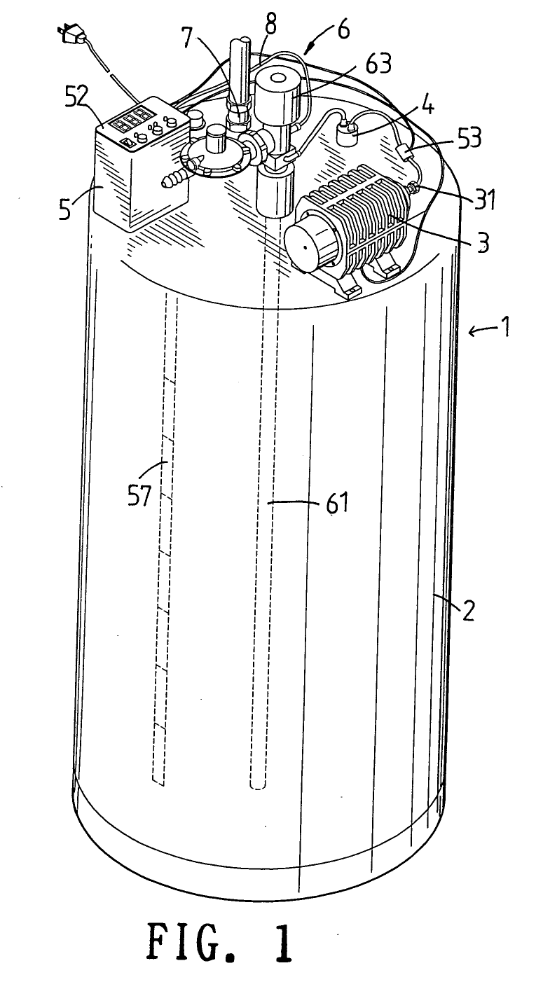

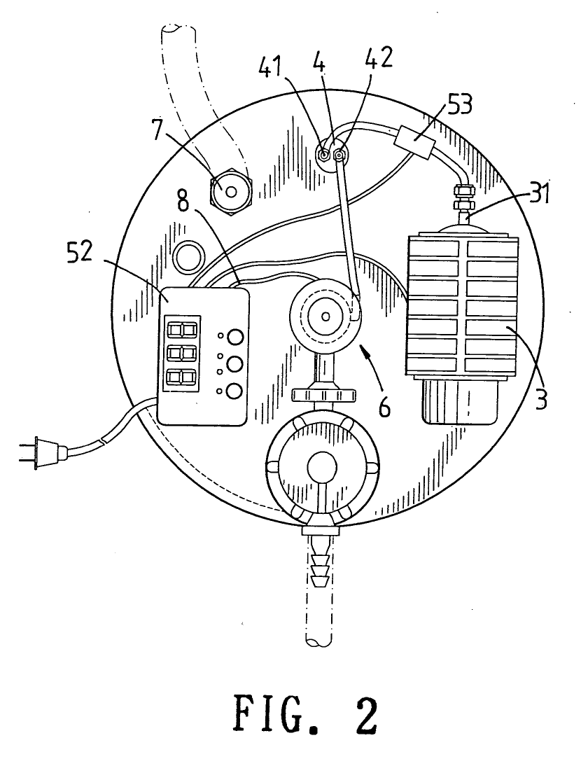

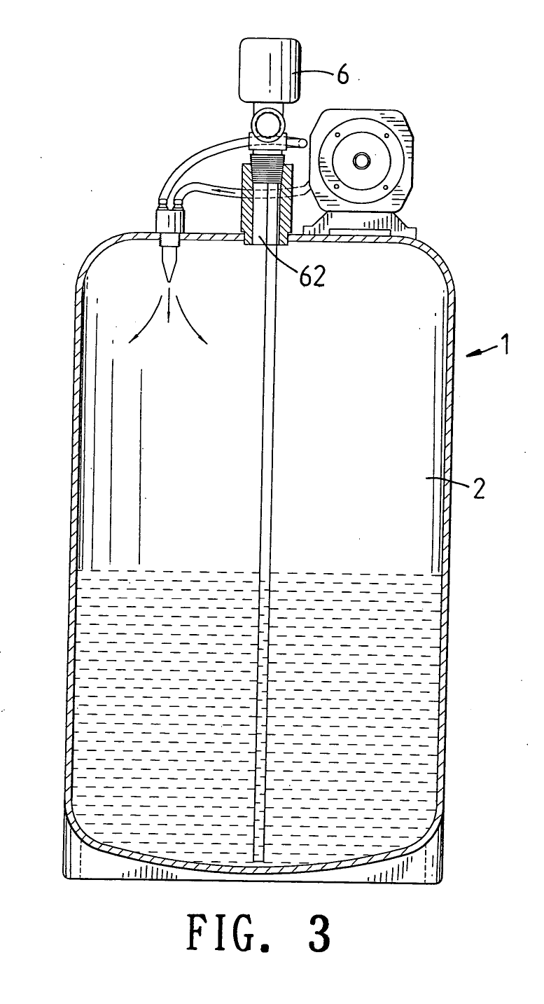

Referring to FIGS. 1 to 3, the fuel and air mixing device 1 of the present invention comprises a tank 2 which has an inlet pipe 7 connected to a top thereof so as to provide fuel therein. A compressor 3 has an outlet 31 which is connected to a first port 41 of a mixing device 4 via a heating member 53 and a valve assembly 6 has a pipe connected to a second port 42 of the mixing device 4. A siphon 61 is connected to the valve assembly 6 and extends in the fuel in the tank 2. An outlet 62 is connected to the valve assembly 6 so as to send vaporized mixture of the fuel and air.

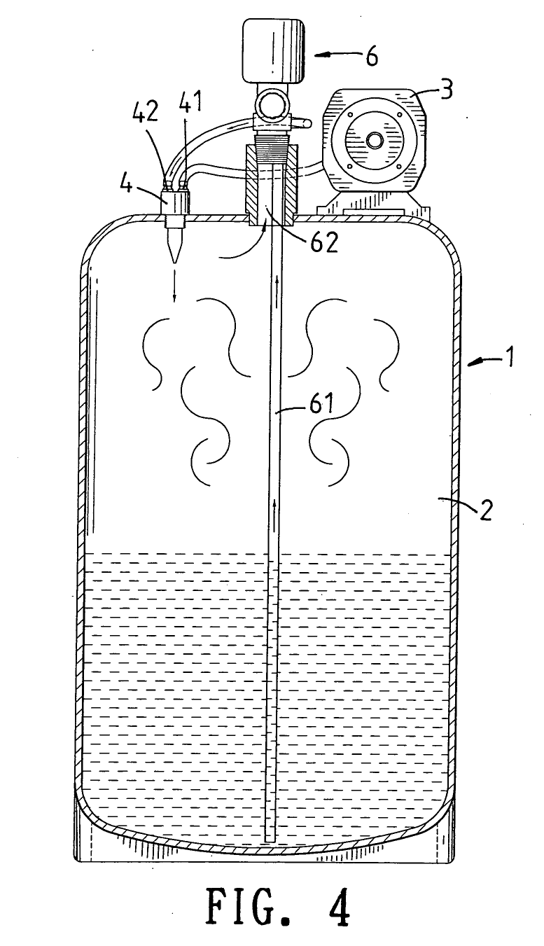

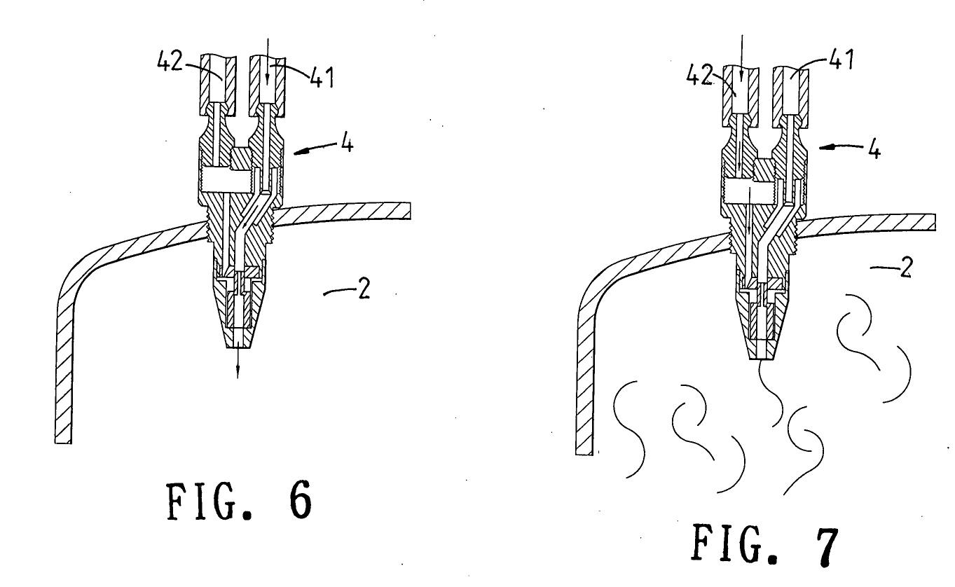

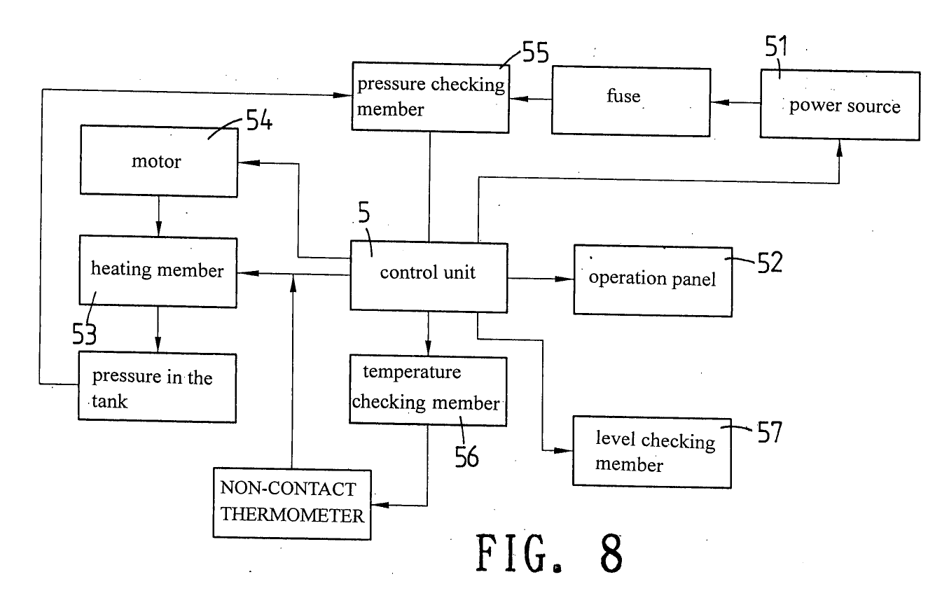

Further referring to FIG. 8, a control unit 5 is connected to a motor 54, a power source 51, a fuse, the valve assembly 6 and the compressor 3 such that the user may control the operation of the compressor 3 and the heating member 53. Further referring to FIGS. 4, 6 and 7, the pressurized air is pumped into the mixing device 4 and enters a space above the fuel in the tank 2 and the fuel is siphoned from the tank 2 by the siphon 61 and the fuel goes through the mixing device 4 and enters the space. The fuel is vaporized and becomes small particles so as to be easily mixed with the air. The mixture of the fuel and air is then sent out of the tank 2 via the outlet 62 by controlling the valve assembly 6 to an open position.

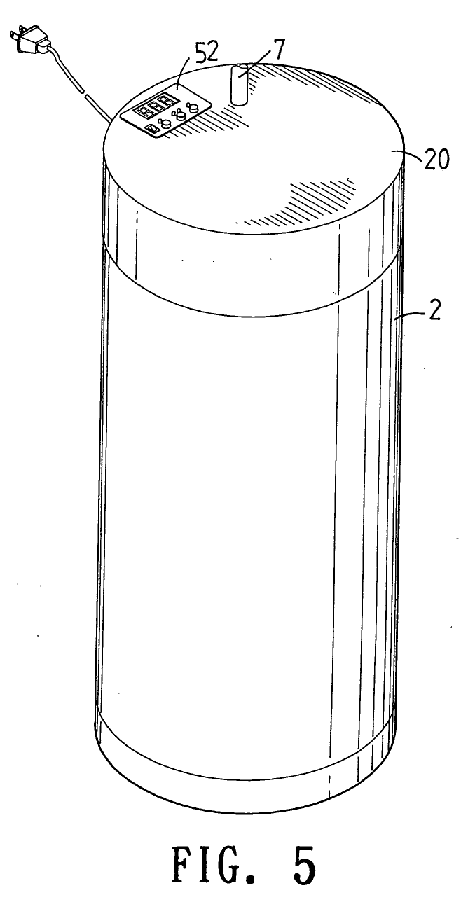

The control unit 5 includes an examining unit and includes a pressure checking member 55 for checking pressure in the tank 2, a temperature checking member 56 connected to the heating member 53, and a level checking member 57 for checking level in the tank 2. The pressure checking member 55 informs the control unit 5 to activate the compressor 3 or shut down the compressor. For family use, the pressure is set to be 0.13 to 0.18 kg, for industry use, the pressure is set to be 0.9 tol kg. When the pressure reaches 0.13 kg for the family use or 0.9 kg for industry use, the compressor 3 is re-activated. The temperature checking member 56 cooperated with a non-contact thermometer to inform the control unit 5 to make the heating mechanism 53 to control the temperature of the air at 105 degrees Celsius so as to remove unnecessary moisture and the temperature of the fuel is controlled between 25 to 30 degrees Celsius. An oil-moisture separation device can also be used to reduce the humidity in the air. When the pressure in the tank 2 reaches a set temperature, the pressure difference between the interior of the tank 2 and the outside of the tank 2 causes the siphon effect. The control unit 5 further includes an operation panel 52 for displaying information of pressure, fuel level, temperature of the fuel and the compressor 3. The panel 52 is connected to a cover 20 which hides the parts on the top of the tank 2 as shown in FIG. 5. It is to be noted that a pipe 8 is connected between the control unit 5 and the valve assembly 6 so as to check the mixture of the fuel and air. For safety sake, the outlet 31 of the compressor 3 and the inlet pipe 7 are mutually locked by a locking system which is not shown.

The method for vaporizing fuel of the present invention comprises the following steps:
step 1: providing pressurized air into a tank 2 in which fuel is received;
step 2: siphoning the fuel form the tank and the fuel passing through a mixing device 4 and entering the tank 2 in a form of small particles which are mixed the pressurized air provided by a compressor 3 in the tank;
step 3: the mixture of the fuel and the air being sent to an outlet 62 of a valve assembly 6 due to pressure difference between the pressure in the tank 2 and outside of the tank 2.

While we have shown and described the embodiment in accordance with the present invention, it should be clear to those skilled in the art that further embodiments may be made without departing from the scope of the present invention.

1. A fuel and air mixing device comprising:
a tank adapted to receive fuel therein;
a compressor connected to a first port of a mixing device and a valve assembly having a pipe connected to a second port of the mixing device, a siphon connected to the valve assembly and extending in the tank, an outlet connected to the valve assembly, and
a control unit connected to the valve assembly and the compressor.

2. The device as claimed in claim 1, wherein a heating mechanism is connected between the compressor and the mixing device.

3. The device as claimed in claim 2, wherein the control unit includes an examining unit which includes a pressure checking member for checking pressure in the tank, a temperature checking member connected to the heating mechanism, and a level checking member for checking level in the tank.

4. The device as claimed in claim 1, wherein the control unit includes an operation panel.

5. The device as claimed in claim 1, wherein the control unit includes an operation panel for displaying information of pressure, fuel level, temperature of the fuel and the compressor.

6. A method for mixing fuel and air, comprising:
step 1: providing pressurized air into a tank in which fuel is received;
step 2: siphoning the fuel form the tank and the fuel passing through a mixing device and entering the tank in a form of small particles which are mixed the pressurized air provided by a compressor in the tank;
step 3: the mixture of the fuel and the air being sent to an outlet of a valve assembly due to pressure difference between the pressure i
